(19) United States
(12) Patent Application Publication
(10) Pub. No.: US 2008/0308693 A1
(43) Pub. Date: Dec. 18, 2008

(54) Multipurpose Sucker

(76) Inventor: Chun-Dong Kim, Suwon (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/094,808

(22) PCT Filed: Jul. 21, 2006
(86) PCT No.: PCT/KR2006/002897

§ 371 Date: May 23, 2008

(30) Foreign Application Priority Data
Nov. 28, 2005 (KR) 1020050114460

(51) Int. Cl. F16B 47/00

(52) U.S. Cl. 248/205.8

(57) ABSTRACT

The present invention relates to a multipurpose sucker; and, more particularly, to a multipurpose sucker capable of improving a suction force of a suction member by having an additional pressure member. The multipurpose sucker can be stably attached without limitation by a shape of a fundamental member connected to the suction member. The multipurpose sucker includes a suction member for attaching to an adherend, which includes a connection part on a top portion thereof, wherein the connection part forms a screw groove on an external circumference thereof, a screw member equipped with the connection part as one body; a pressure member for pressing the suction member, which includes a connection hole for being assembled with the connection part, wherein the connection hole has a screw groove on an inner wall of the connection hole and a functional member which is assembled with the screw member. Therefore, the multipurpose sucker in accordance with the present invention has an effect of firmly adhering to an adherend by having a pressure member. Also, the multipurpose sucker in accordance with the present invention has various fields of usage without limitation in shape and function of a functional member, by making a pressure member itself rotates to make the center of the suction member available for a functional member of any shape. And also, the multipurpose sucker in accordance with the present invention can prevent the suction member from being separated from the adherend in advance by knowing the adhesion strength of the suction member by the cap made from an elastic material.

### TECHNICAL FIELD

The present invention relates to a multipurpose sucker; and, more particularly, to a multipurpose sucker capable of improving a suction force of a suction member by having an additional pressure member. The multipurpose sucker can be stably attached without limitation by a shape of a fundamental member connected to the suction member.

### BACKGROUND ART

Generally, a sucker is made from rubber material and used for fixing a body to a surface, such as a wall. However, a sucker is easily detached as external air flows into the inside of a suction surface of the sucker little by little as time goes by. Also, it is hard to hook or hang heavy objects on the sucker, because of its weak suction force. According to one prior art, there has been suggested a sucker with an improved suction force in order to solve the problems shown above.

FIG. 1 is a sectional view illustrating a conventional sucker with an improved suction force. The conventional sucker includes a suction member 110 including a connection part 111 at the upper part thereof, a screw member 112 located at the center of the connection part 111, a pressure member 120 and a functional member 130. A hole is made at the center of the upper part of the pressure member 120, and the functional member 130 includes a female screw which is assembled with the screw member 112. In using the conventional sucker, the suction member 110 is pressed onto an adherend 100, and the pressure member 120 is put through the screw member 112, and then the functional member 130 is assembled with the screw member 112. As the functional member 130 moves toward the adherend 100, the screw member 112 is pulled towards the functional member 130 and there is formed a vacuum between the lower side of the suction member 110 and the adherend 100. Also, the pressure member 120 generates a strong suction force by pressing the upper side of the suction member 110.

However, the conventional sucker has a problem that the assembly of the functional member gets loose to weaken the suction force as the functional member is used over and over again.

FIG. 2 shows a sectional view of another conventional sucker with an improved adhesion force. The sucker is made from a synthesized rubber or soft plastics and it is composed of a suction member 210 in a hemispherical shape, a supporting cap 220 for supporting the periphery of an upper side of the suction member 210, and a supporting axis 230 equipped by penetrating the supporting cap 220, and an operating lever 240. The operating lever 240 moves up the center of the suction member 210 while pushing down the supporting cap. When the operating lever 240 is pulled down, with the suction member 210 adhered closely to the adherend 200, the said operating lever 240 lifts up the suction member 210 according to the principle of levers. At this time, the periphery of the suction member 210 is compressed and fixed to the adherend 200 by the supporting cap 220 with only the center part lifted, resulting in formation of a negative pressure close to a vacuum between the adherend and the suction member 210. Accordingly, the sucker adheres to the adherend 200.

However, the sucker has a hanger tool fixed to its operational level, and so the operating level makes a seesaw movement along with the hanger. This puts a limit on the shape and function of the hanger tool. Also, the center of the sucker can be lifted with a limit, which results from the limited movement range of the operating lever. Therefore, the degree of a vacuum formed by operating the operating level is not high enough to support a heavy object, so that the sucker have not been used in the various fields.

### DISCLOSURE OF INVENTION

### Technical Problem

Therefore, the present invention has been proposed in order to overcome the above-described problems in the related art. It is, therefore, an object of the present invention to provide a multipurpose sucker capable of improving a suction force by having a pressure member.

It is another object of the present invention to provide a multipurpose sucker in which a functional member itself is rotated to be assembled with a connection part.

It is still another object of the present invention to provide a multipurpose sucker which enables users to check if an suction force of a sucking member gets weak or not.

### Technical Solution

In accordance with one aspect of the present invention, there is provided a multipurpose sucker, including a suction member for attaching to an adherend, which includes a connection part on a top portion thereof, the connection part forming a screw groove on an external circumference thereof; a screw member equipped with the connection part as one body; a pressure member for pressing the suction member, which includes a connection hole for being assembled with the connection part, the connection hole has a screw groove on a wall of thereof; and a functional member which is assembled with the screw member.

### ADVANTAGEOUS EFFECTS

Therefore, the multipurpose sucker in accordance with the present invention has an effect of firmly adhering to an adherend by having a pressure member.

Also, the multipurpose sucker in accordance with the present invention has various fields of usage without limitation in shape and function of a functional member, by making a pressure member itself rotates to make the center of the suction member available for a functional member of any shape.

And also, the multipurpose sucker in accordance with the present invention can prevent the suction member from being separated from the adherend in advance by knowing the adhesion strength of the suction member by the cap made from an elastic material.

### BRIEF DESCRIPTION OF THE DRAWINGS

FIG. 1 is a cross-sectional view showing a conventional sucker;

FIG. 2 is a cross-sectional view showing another conventional sucker;

FIG. 3 is an exploded perspective view showing a multipurpose sucker in accordance with a first embodiment of the present invention;

FIG. 4 is an exploded perspective view showing a multipurpose sucker in accordance with a second embodiment of the present invention;

FIG. 5 is a cross-sectional view showing a cap including an elastic part in accordance with the second embodiment of the present invention at the time of use;

FIG. 6 is a cross-sectional view showing a cap including an elastic part in accordance with the second embodiment of the present invention at the time of use;

FIG. 7 is a cross-sectional view showing a multipurpose sucker in accordance with the present invention at the time of use;

FIG. 8 is a cross-sectional view showing a multipurpose sucker in accordance with the present invention at the time of use;

FIG. 9 is a cross-sectional view showing a multipurpose sucker in accordance with the present invention at the time of use;

FIG. 10 is a perspective view showing a multipurpose sucker in accordance with a third embodiment of the present invention;

FIG. 11 is an exploded perspective view showing a multipurpose sucker in accordance with a fourth embodiment of the present invention;

FIG. 12 is an exploded perspective view showing a multipurpose sucker in accordance with a fifth embodiment of the present invention;

FIG. 13 is an exploded perspective view showing a multipurpose sucker in accordance with a sixth embodiment of the present invention; and

FIG. 14 is a side view showing a multipurpose sucker in accordance with the sixth embodiment of the present invention at the time of use.

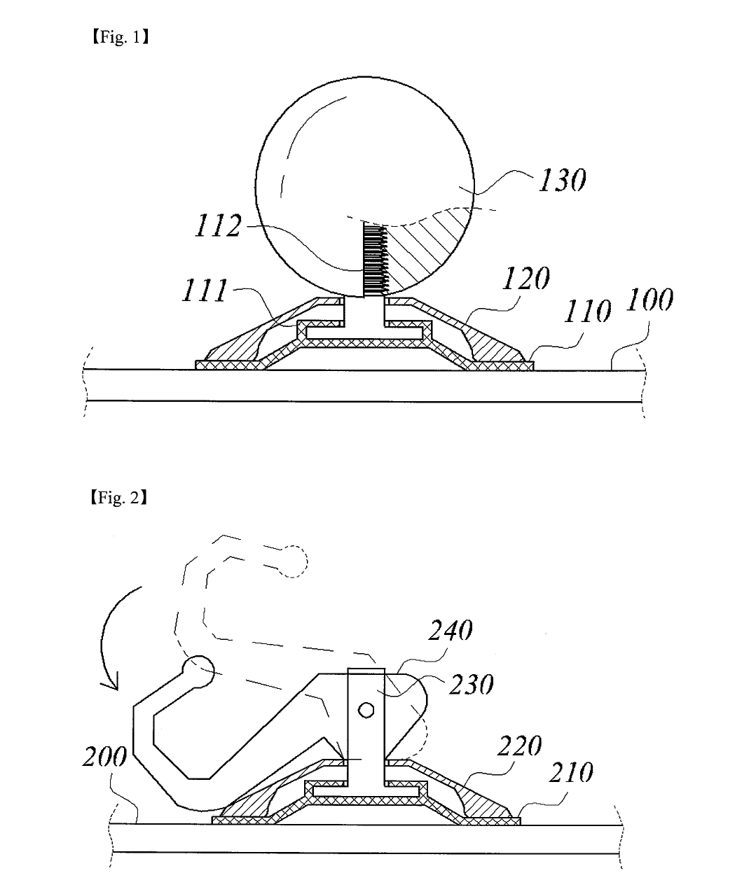

### DESCRIPTIONS OF REFERENCE NUMERALS FOR MAJOR PARTS IN THE DRAWINGS

300: adherend
310, 410, 710: suction member
311, 411: connection part
312, 412: screw member
320, 720: pressure member
321, 721: connection hole
330, 630, 730, 830: functional member
440, 440a, 440b: cap

### MODE FOR THE INVENTION

Hereinafter, a detailed description for the these objects, technical constructions and functional effects according thereto will be further clearly understood in detail by a following detailed description with reference to the accompanying drawings which illustrate preferred embodiments of the present invention.

FIG. 3 is an exploded perspective view showing a multipurpose sucker in accordance with a first embodiment of the present invention.

The multipurpose sucker in accordance with the first embodiment of the present invention is adhered and fixed to an adherend 300 and includes a suction member 310 which is made from soft synthetic resins, a pressure member 320 which secures the adhesion of the suction member 310, and a functional member 330 which is connected with the suction member 310. The functional member can have various shapes and functions.

The suction member 310 includes a connection part 311 in a shape of a disc and a screw member 312 connected to the connection part 311 as one body and located on the center of the connection part 311. The connection part 311 in accordance with the first embodiment of the present invention has a screw groove formed on an external circumference to be jointed with the pressure member 320.

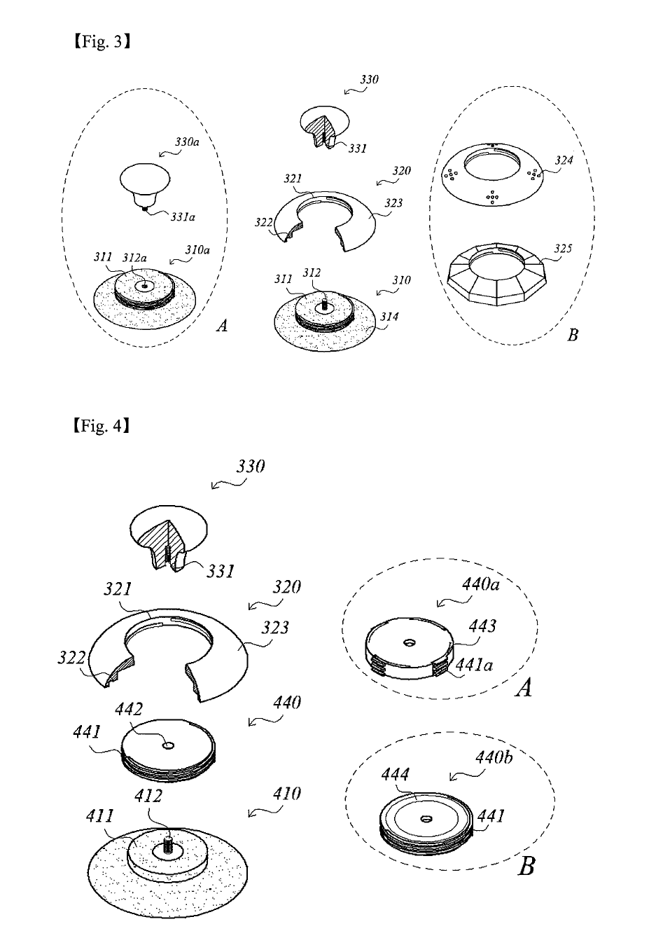

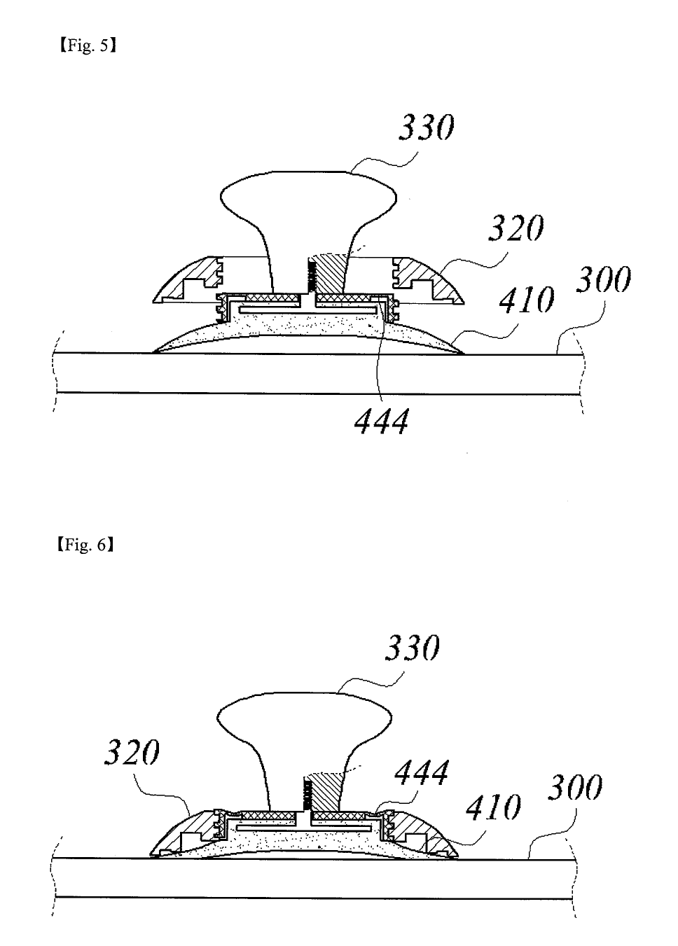

As shown in FIG. 4, the connection part 411 in accordance with the second embodiment of the present invention has a smooth circumference without a screw groove. When the circumference of the connection part 411 is made smooth, a cap 440 to be assembled with the pressure member 320 is equipped. A hole 442 is formed at the center of the cap 440, and screw grooves are formed on the circumference of the cap 440. The cap 440 is combined with the connection part 411 by interference fitting, and is located to be fixed between the functional member 330 and the connection part 411. The cap 440 can be made of material which is stronger than the material of the suction member 410 or the same material as the pressure member 320.

Also, the cap 440a in accordance with another embodiment of the present invention is made from an elastic material as shown in FIG. 4A, and includes a screw groove part which partially forms screw grooves 441a at the external circumference of the cap 440. The screw groove part 443 is partially cut from the cap 440a to move up and down. When the pressure member is assembled into the cap, the screw groove part 443 elevates due to the increasing adhesion strength of the suction member. And the screw groove part 443 descends as the adhesion strength of the suction member decreases. Therefore, one can check if the suction member is tightly adhered from the height of the screw groove part and further tight the pressure member to prevent the suction member from slipping from the adherend.

The cap 440b in accordance with another embodiment of the present invention is made from elastic material as shown in FIG. 4B, and includes an elastic part 444 at the rim of the upper part thereof, wherein a thickness of the elastic part of the cap is made thinner than the thickness of the center part of the cap. FIG. 5 and FIG. 6 are sectional views of the cap 440b including the elastic part 444, and the upper surfaces of the elastic part 444 and the cap 440b are flat before the pressure member 320 is assembled with the cap 440b. However, when the cap 440b are assembled into the pressure member 320, the elastic part 444 forms furrows as the cap 440 elevates toward the functional member 330. In this manner, the adhesion of the suction member 310 can be judged from the furrows of the elastic part 444. When the furrows of the elastic part get flat, the pressure members 320 can be fastened with the cap 440 to prevent the suction member 310 from being separated from the adherend 300.

As shown in FIG. 3 and FIG. 4, the screw member 312 and 412 in accordance with a first and a second embodiments, which connects the functional member 330 and the suction member 310, has a form of male screw made as one body with connection part 311 and 411 at the center of the connection part 311 and 411. The screw member 312a in accordance with another embodiment of the present invention can be connected to the functional member 330a by including a female screw instead of a male screw at the center of the connection part 311.

The pressure member 320 includes a connection hole 321 for jointing with the connection part 311 and a pressure part 322 for improving the adhesion of the suction member 310. The connection hole 321 is made to have the same circumference as the circumference of the connection part 311, and screw grooves are formed at the inner wall of the connection hole 321 to be jointed with the connection part 311. The pressure part 322 is located on the lower surface of the pressure member 320, and forms a cylindrical base and exerts pressures onto the suction member 310 by contacting to the upper surface 314 of the suction member. As shown in FIG. 3B, a bump 324 or a facet can be formed on the circumference of the pressure member for an easy rotation of the pressure member 320.

The functional member 330 includes a female screw 331 for being assembled with the screw member 312 and the form of the functional member 330 can be transformed according to the usage. The functional member 330a in accordance with another embodiment of the present invention, as shown in FIG. 3A, includes a male screw 331a instead of a female screw in order to be assembled with the screw member 312a.

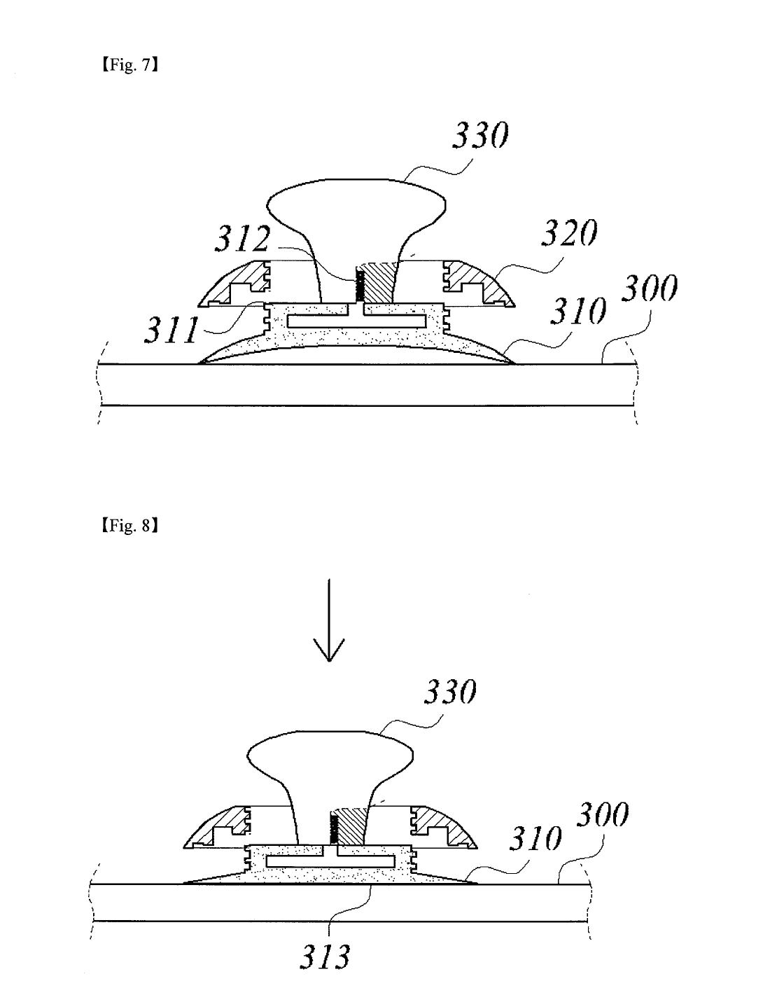

FIG. 7, FIG. 8 and FIG. 9 are cross-sectional views of a multipurpose sucker in accordance with the present invention at the time of use.

FIG. 7 shows a state that the suction member 310 in accordance with the present invention is set on the adherend 300. At this time, the periphery of the lower surface of the suction member 313 is in contact with the adherend 300. And the lower surface of the suction member 313 is in concave shape, and a little amount of air is included between the adherend 300 and the lower surface of the suction member 313. The connection part 311 on the upper part of the suction member is not assembled with the pressure member 320, and the screw member 312 is assembled with the functional member 330.

FIG. 8 shows that the functional member 330 is pressed toward the direction of the adherend 300. At this time, the lower surface of the suction member 313 is completely adhered to the adherend 300. However, at this state, the suction strength is so weak that the suction member 310 can be detached from the adherend 300 by exerting even a little bit of force.

FIG. 9 shows that the connection hole 321 of the pressure member is jointed with the connection part 311 and the pressure part 322 of the pressure member is in contact with the upper surface 314 of the suction member. At a state that the lower surface of the suction member 313 is closely adhered to the adherend 350, the pressure member 320 is rotated to the direction of the adherend 300 and assembled with the connection part 311. As a result, the connection part 311 is lifted to the opposite direction of the adherend 300 and thus a vacuum is formed between the lower surface of the suction member 313 and the adherend 300. When a vacuum 350 starts to be formed, it becomes hard to rotate the pressure member 320 because the frictional force between the upper surface 314 of the suction member and the pressure part 322 increases. At this time, if the functional member 330 is pulled to the opposite direction of the adherend 300, it is possible to rotate the pressure member 320 further for there occurs more space between the upper surface of the suction member 314 and the pressure part 322. After the pressure part 322 is in a complete contact with the upper surface 314 of the suction member, if the functional member 330 is released, the pressure part 322 presses the upper surface 314 of the suction member as strongly as the functional member 330 has been pulled. As shown above, by directly jointing the pressure member 320 with the connection part 311, it is possible to freely use the screw member 312 as well as improve the adhesion of the suction member 310.

Also, the suction member 310 can be separated from the adherend 300, not by exerting force to the functional member 330, but by removing the pressure member 320 from the connection part 311 with the force as strong as that exerted at the time of its assembly to the connection part 311. It is because air does not flow into between the adherend 300 and the suction member 310 which is closely adhered with the pressure member 320.

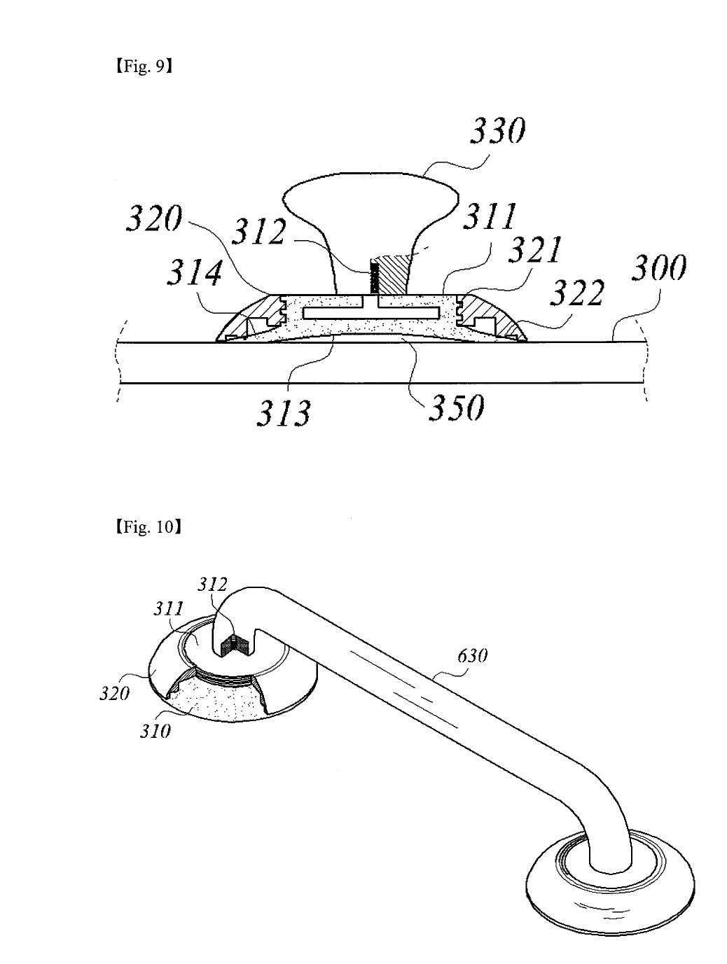

FIG. 10 is a side view showing a multipurpose sucker in accordance with a third embodiment of the present invention.

The multipurpose sucker in accordance with a third embodiment of the present invention is equipped with two sets of the components of the multipurpose sucker other than a functional member, and a functional member 630, with a ‘□’ shape.

The functional member 630 is assembled with the screw member 312, and then the suction member 310 is adhered to the adherend 300. At this time, pressure member 320 is not assembled with the connection part 311 and located between the functional member 630 and the suction member 310. The suction member 310 is closely adhered to the adherend 300, and then the connection part 311 is assembled with the pressure member 320. The resulting multipurpose sucker can be used for a user's purpose.

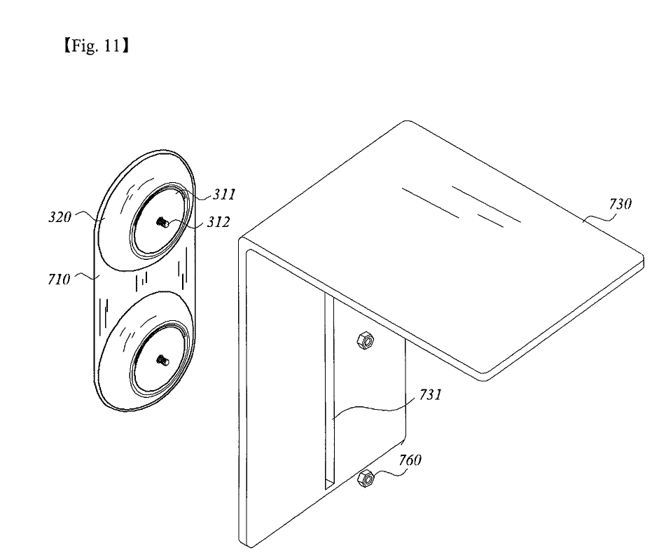

FIG. 11 is an exploded view showing a multipurpose sucker in accordance with a fourth embodiment of the present invention.

The multipurpose sucker in accordance with a fourth embodiment of the present invention includes at least two connection parts 311 and screw member 312 at the upper surface of a suction member 710. The multipurpose sucker can be used to fix a functional member 730, which is used as a support for a shelf. The functional member 730 has a long hole 731 in the direction of length. The functional member 730 is fixed by inserting at least two screw members 312 into the hole of the functional member 731 and assembling nuts 760 with the screw members 312. By making the area of the suction member 710 bigger than that of the lower surface of the pressure member 320, the suction member 320 can be assembled with a plurality of pressure members 710. Therefore, it is possible to prevent the multipurpose sucker from falling when any one of the pressure members fails to work. As shown above, it is possible to obtain an effect of using two suction members by using one suction member which includes at least two connection parts 311. Also, according to the functional member 730, it is possible to sustain a big load by forming a number of connection parts 311 at the upper part of the suction member 710.

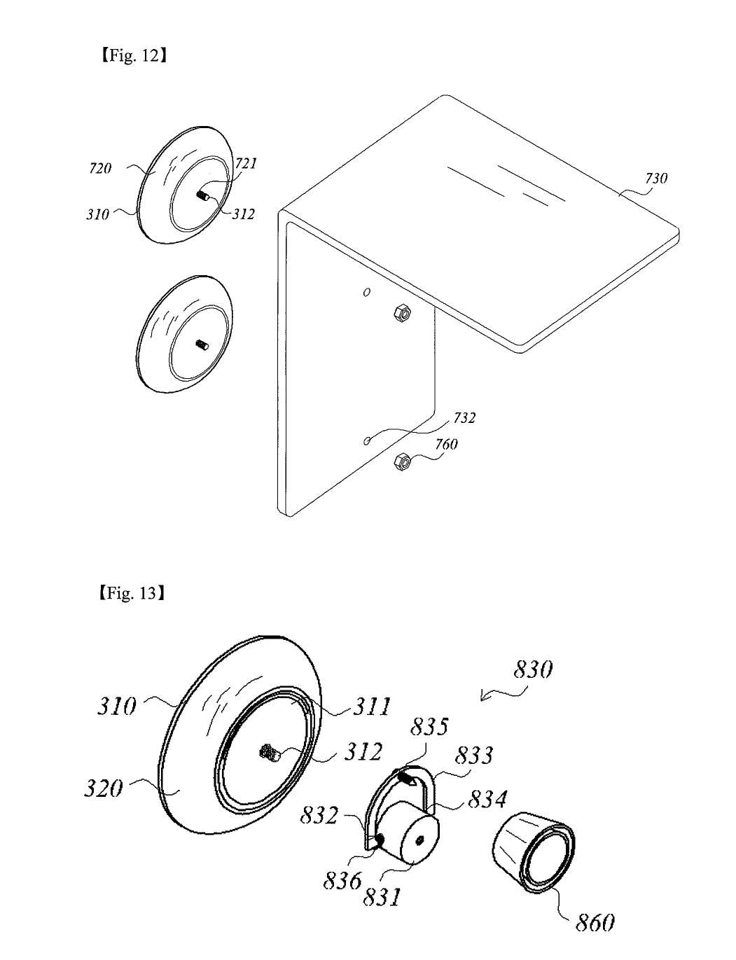

FIG. 12 is an exploded view showing a multipurpose sucker in accordance with a fifth embodiment of the present invention.

As a pressure member 720 in accordance with a fifth embodiment of the present invention has a connection hole, the diameter of which is formed to be same as a diameter of a screw member 312, and so, the pressure member 720 is directly assembled to the screw member 312 to exert pressure to the suction member 310, without forming screw grooves on the circumference or having an extra cap. Such multipurpose sucker is assembled by inserting each screw member 312 into the hole 732 of the functional member 730 and using the a nut 760 in case the hole 732 is formed in the functional member 730.

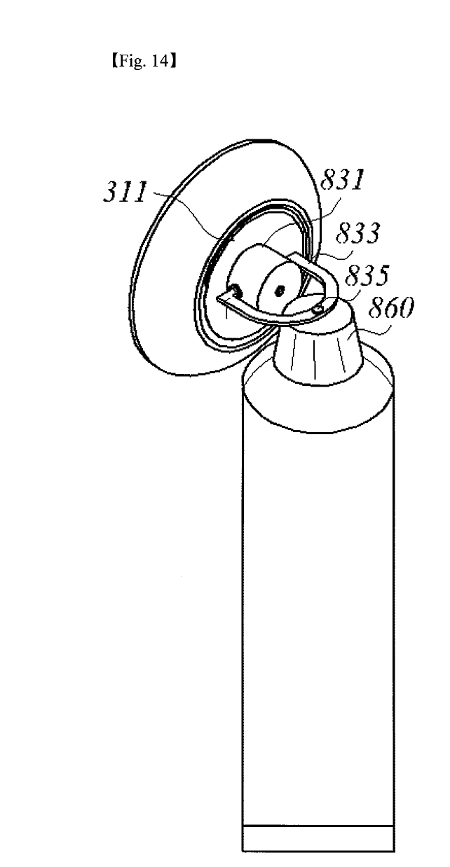

FIG. 13 is an exploded view showing a multipurpose sucker in accordance with a sixth embodiment of the present invention and FIG. 14 is a side view showing a multipurpose sucker in accordance with the sixth embodiment of the present invention at the time of use.

A functional member 830 in accordance with a sixth embodiment of the present invention includes a hinge member 831, hanger member 833 where a tap screw is attached, and a torsion spring 836. The hinge member 831 is assembled with the screw member 312 and a hole 832 for fixing the hanger member 833 perpendicularly to the direction of the axis of the hinge member is formed. One side of the hanger member 833 is inserted into the hole 832 of the hinge member, and a tap screw 835 is attached to the other side. The torsion spring 836 is inserted into a straight line part 834 of the hanger member, and the straight line part 834 of the hanger member is inserted into the hole 832 of the hinge nut. When the functional member 830 is assembled to the screw member 312, the hanger member 833 can rotate by the torsion spring 836. The hanger member 833 is originally positioned parallel with an upper surface of the connection part 311, as shown in FIG. 12. And in case inserting and fixing the tap screw into the upper part of a lid 870 of tooth paste or pen, the hanger member turns around due to the weight of the fixed object which is attached to the tap screw 835. If the object is removed, the restoring force of the torsion spring 836 makes the hanger member 833 turn around back to the original position. As shown above, by connecting the functional member 830 to the lid 870 through the tap screw, users can use the object without losing its lid 870. Though not shown in here, by inserting a soft synthetic resin with a predetermined thickness into the tap screw, the sharp end of the tap screw 835 is wrapped safely.

While the present invention has been just described with respect to certain preferred embodiments of the present invention, other modifications and variations for the present invention may be made without departing from the scope of the present invention.

1. A multipurpose sucker, comprising:
a suction member for attaching to an adherend, which includes a connection part on a top portion thereof, wherein the connection part forms a screw groove on an external circumference thereof;
a screw member equipped with the connection part as one body;
a pressure member for pressing the suction member, which includes a connection hole for being assembled with the connection part, wherein the connection hole has a screw groove on an inner wall of the connection hole; and
a functional member which is assembled with the screw member.

2. A multipurpose sucker, comprising:
a suction member including a connection part on an upper part thereof;
a screw member equipped with the connection part as one body;
a cap with a screw groove on an external circumference thereof for being fixed with the connection part by interference fitting;
a pressure member for pressing the suction member, which includes a connection hole for being assembled with the cap, wherein the connection hole has a screw groove on an inner wall of the connection hole; and
a functional member which is assembled with the screw member.

3. The multipurpose sucker as recited in claim 2, wherein the cap includes a screw groove part which forms the screw groove on a portion of the external circumference of the cap.

4. The multipurpose sucker as recited in claim 2, wherein, in a thickness of an upper part of the cap, an elastic part which is adjacent to the screw groove of the cap has a thickness thinner than that of a central part of the cap.

5. The multipurpose sucker as recited in claim 3 or 4, wherein the cap is made from an elastic material.

6. The multipurpose sucker as recited in claim 3, wherein the screw groove part is partially cut from the cap to move up and down.

7. A multipurpose sucker, comprising:
a suction member including a screw member at an upper part thereof;
a pressure member for pressing the suction member with a connection hole which has an inner diameter same as an outer diameter of the screw member,
wherein a screw groove is included on an inner wall of the connection hole; and
a functional member which is assembled with the screw member.

8. The multipurpose sucker as recited in anyone of claims 1, 2, 3 and 4, wherein the screw member has a male screw type and the functional member includes a female screw which is assembled with the screw member.

9. The multipurpose sucker as recited in anyone of claims 1, 2, 3 and 4, wherein the screw member has a female screw type, and the functional member includes a male screw which is assembled with the screw member.

10. The multipurpose sucker as recited in anyone of claims 1, 2, 3 and 4, wherein the suction member includes at least two connection parts at an upper part of the suction member.

11. The multipurpose sucker as recited in anyone of claims 1, 2, 3, 4 and 7, wherein a bump or a facet is further included at the external circumference of the pressure member in order to make the pressure member rotated easily by users.

12. The multipurpose sucker as recited in anyone of claims 1, 2, 3, 4 and 7, wherein the functional member is ‘□’ shaped, and two sets of the screw member and the suction member are equipped on ends of the functional member, respectively.

13. The multipurpose sucker as recited in anyone of claims 1, 2, 3, 4 and 7, wherein the functional member further includes:
a hinge member formed with a hole in a direction perpendicular to an axis and assembled with the screw member; and
a hanger member inserted into the hole, which has a tap screw fused into one side thereof for fixing a lid.

14. The multipurpose sucker as recited in claim 13, wherein the multipurpose sucker further comprises a torsion spring inserted into a side of the hanger member for rotating and restoring the hanger member.
